(19) United States
(12) Patent Application Publication
(10) Pub. No.: US 2026/0128249 A1
(43) Pub. Date: May 7, 2026

(54) ELECTRON SOURCE

(71) Applicant: Kabushiki Kaisha Toshiba, Tokyo (JP)

(72) Inventors: Hisao MIYAZAKI, Yokohama Kanagawa (JP); Shigeya KIMURA, Yokohama Kanagawa (JP); Shinya NUNOUE, Ichikawa Chiba (JP); Akira FUJIMOTO, Kawasaki Kanagawa (JP); Yuma YAMAGUCHI, Kawasaki Kanagawa (JP)

(21) Appl. No.: 19/277,789

(22) Filed: Jul. 23, 2025

(30) Foreign Application Priority Data
Nov. 1, 2024 (JP) 2024-193064

(51) Int. Cl. H01J 3/02

(52) U.S. Cl. CPC H01J 3/021

(57) ABSTRACT

According to one embodiment, an electron source includes a first member. The first member includes a first semiconductor layer and a second semiconductor layer. The first semiconductor layer has a first bandgap energy and is of p-type. The second semiconductor layer includes a first region. The first region has a second bandgap energy larger than the first bandgap energy, and is of n-type.

### CROSS-REFERENCE TO RELATED APPLICATIONS

This application is based upon and claims the benefit of priority from Japanese Patent Application No. 2024-193064, filed on Nov. 1, 2024; the entire contents of which are incorporated herein by reference.

### FIELD

Embodiments described herein relate generally to an electron source.

### BACKGROUND

For example, electrons emitted from an electron source are used in electronic devices such as an electron beam drawing device. Improved performance is desired in electron sources.

### BRIEF DESCRIPTION OF THE DRAWINGS

FIG. 1 is a schematic cross-sectional view illustrating an electron source according to a first embodiment;

FIG. 2 is a schematic diagram illustrating the electron source according to the first embodiment;

FIGS. 3A and 3B are schematic diagrams illustrating the electron sources according to the first embodiment;

FIG. 4 is a schematic cross-sectional view illustrating an electron source according to a second embodiment;

FIG. 5 is a schematic diagram illustrating an electron source according to the second embodiment; and

FIGS. 6A to 6C are schematic diagrams illustrating electron sources according to the second embodiment.

### DETAILED DESCRIPTION

According to one embodiment, an electron source includes a first member. The first member includes a first semiconductor layer and a second semiconductor layer. The first semiconductor layer has a first bandgap energy and is of p-type. The second semiconductor layer includes a first region. The first region has a second bandgap energy larger than the first bandgap energy, and is of n-type.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

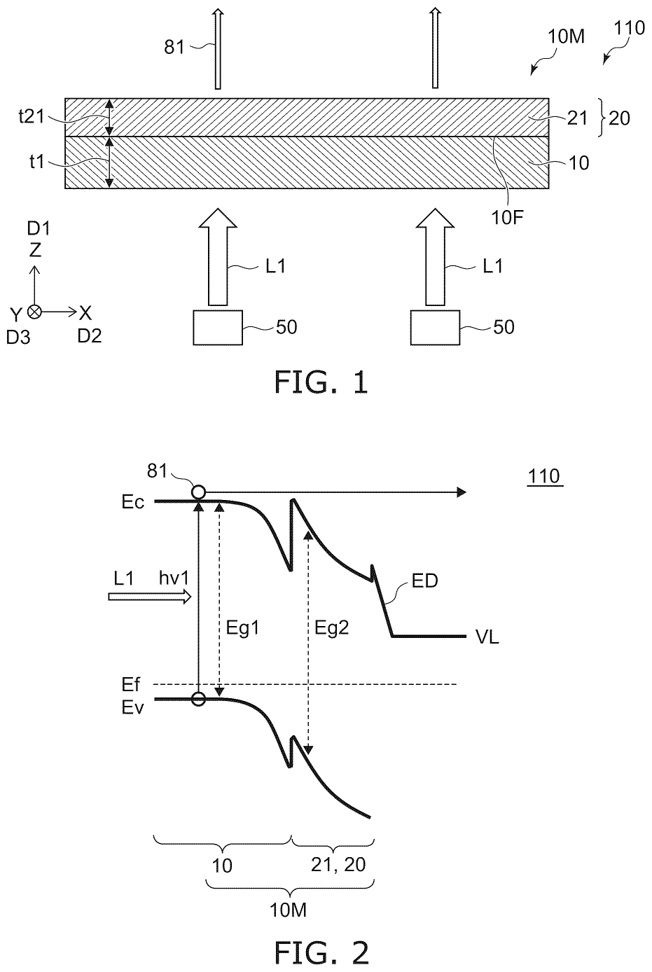

FIG. 1 is a schematic cross-sectional view illustrating an electron source according to the first embodiment.

As shown in FIG. 1, an electron source 110 according to the embodiment includes a first member 10M. The first member 10M includes a first semiconductor layer 10 and a second semiconductor layer 20. The second semiconductor layer 20 includes a first region 21.

A first direction D1 from the first semiconductor layer 10 to the second semiconductor layer 20 is defined as a Z-axis direction. One direction perpendicular to the Z-axis direction is defined as an X-axis direction. A direction perpendicular to the Z-axis direction and the X-axis direction is defined as a Y-axis direction.

The first semiconductor layer 10, the second semiconductor layer 20, and the first region 21 are layered along the X-Y plane. The first semiconductor layer 10 includes a first face 10F facing the first region 21. The first face 10F is aligned along the X-Y plane.

In the embodiment, the first semiconductor layer 10 includes InₓAl_{y}Ga_{1-x-y}N (0≤x≤1, 0≤y≤1, x+y≤1) and includes magnesium. The first semiconductor layer 10 is, for example, a p-type nitride layer.

The first region 21 included in the second semiconductor layer 20 includes diamond and a first element. The first element includes at least one selected from the group consisting of phosphorus and nitrogen. The first region 21 includes, for example, n-type diamond.

When light L1 is incident on such a first member 10M, electrons 81 are emitted. In the embodiment, highly efficient electron emission is obtained.

For example, mobile carriers (electrons) are generated in the first semiconductor layer 10 by irradiation with light L1. The generated electrons 81 move efficiently to the second semiconductor layer 20 (for example, the first region 21). The electrons 81 are efficiently emitted from the second semiconductor layer 20 (for example, the first region 21) to the outside. High electron emission efficiency is obtained. According to the embodiment, an electron source capable of improving characteristics is provided. For example, by combining the first semiconductor layer 10 of p-type and the first region 21 of n-type, the electrons 81 can move efficiently to the first region 21.

Thus, the second semiconductor layer 20 is configured to emit electrons 81 in response to the light L1 incident on the first member 10M.

As shown in FIG. 1, the electron source 110 may further include a light emitting portion 50. The light emitting portion 50 is configured to emit light L1 to the first member 10M. The light emitting portion 50 may include, for example, a semiconductor light emitting element (for example, an LED, etc.). In one example, the first semiconductor layer 10 is located between the light emitting portion 50 and the first region 21.

As shown in FIG. 1, as already described, the first semiconductor layer 10 includes the first face 10F facing the first region 21. The first face 10F is along the X-Y plane. A plurality of light emitting portions 50 may be provided. The electron source 110 may include a plurality of light emitting portions 50. The plurality of light emitting portions 50 are arranged along the first face 10F. The plurality of light emitting portions 50 may be along the first face 10F. At least a part of the plurality of light emitting portions 50 may be arranged along, for example, a second direction D2 crossing the first direction D1. At least a part of the light emitting portions 50 may be arranged along, for example, a third direction D3. The third direction D3 crosses a plane including the first direction D1 and the second direction D2.

The light L1 emitted from each of the plurality of light emitting portions 50 may be incident on different positions on the first member 10M. Electrons 81 may be emitted from different positions on the first member 10M.

In one example, the composition ratio x may be not less than 0 and not more than 0.5. In this case, the composition ratio y may be not less than 0 and not more than 0.1. When light L1 is irradiated, mobile electrons 81 can be efficiently generated.

The concentration of the first element (e.g., phosphorus or nitrogen) in the first region 21 may be 1×10¹⁸ cm⁻³ or more. The first region 21 effectively functions as an n-type region. The concentration of magnesium in the first semiconductor layer 10 may be 1×10¹⁸ cm⁻³ or more. The first semiconductor layer 10 effectively functions as a p-type layer.

As shown in FIG. 1, a thickness of the first region 21 in the first direction D1 from the first semiconductor layer 10 to the first region 21 is defined as a first region thickness t21. In the embodiment, the first region thickness t21 is preferably 12 nm or more. Such a first region thickness t21 effectively lowers the barrier when the electrons 81 move from the first semiconductor layer 10 to the first region 21. For example, the electrons 81 can move efficiently to the first region 21. Higher efficiency is easily obtained. The first region thickness t21 may be, for example, not less than 3 nm and not more than 100 nm.

As shown in FIG. 1, a thickness of the first semiconductor layer 10 in the first direction D1 is defined as a first thickness t1. In the embodiment, the first thickness t1 may be, for example, not less than 10 nm and not more than 1000 nm.

FIG. 2 is a schematic diagram illustrating the electron source according to the first embodiment.

FIG. 2 illustrates a band profile in the electron source 110. The horizontal axis of FIG. 2 is the position in the Z-axis direction. FIG. 2 illustrates the valence band energy Ev and the conduction band energy Ec.

As shown in FIG. 2, the first semiconductor layer 10 of p-type contacts the first region 21 of n-type. Charges move so that the Fermi level Ef of the first semiconductor layer 10 and the Fermi level Ef of the first region 21 match. As a result, a diffusion potential is generated between the first semiconductor layer 10 and the first region 21. The conduction band energy Ec in the first region 21 decreases along the direction from the first semiconductor layer 10 to the first region 21. When light L1 is incident on the first semiconductor layer 10, the electron 81 is excited to the conduction band energy Ec by the energy hv1 of the light L1. The electron 81 can move from the first semiconductor layer 10 to the first region 21 by overcoming the barrier between the conduction band energy Ec in the first semiconductor layer 10 and the conduction band energy Ec in the first region 21. The electron 81 that has moved to the first region 21 is efficiently emitted from the first region 21 to the outside. The electrons 81 are emitted to the outside of the vacuum level VL with high efficiency.

For example, the conduction band energy Ec in the first region 21 is lower than the conduction band energy Ec in the first semiconductor layer 10. Electrons 81 can efficiently overcome the barrier.

For example, the first semiconductor layer 10 has a first band gap energy Eg1. The first region 21 has a second band gap energy Eg2. The first band gap energy Eg1 is smaller than the second band gap energy Eg2. Due to this energy relationship, for example, electrons 81 can be efficiently generated in the first semiconductor layer 10. Efficient electron emission can be obtained.

For example, the first member 10M includes the first semiconductor layer 10 of p-type having the first band gap energy Eg1, and the second semiconductor layer 20 including the first region 21. The first region 21 is n-type and has the second band gap energy Eg2 larger than the first band gap energy Eg1. Such a first member 10M provides highly efficient electron emission. An electron source with improved characteristics can be provided.

Light L1 is incident on the first member 10M having such a band gap energy relationship and mutually different conductivity types. The second semiconductor layer 20 (for example, the first region 21) is configured to emit electrons 81 in response to the light L1 incident on the first member 10M. The energy hv1 of the light L1 is larger than the first band gap energy Eg1. Highly efficient electron emission is obtained.

For example, even if the energy hv1 of light L1 is smaller than the second band gap energy Eg2, as long as the energy hv1 of light L1 is larger than the first band gap energy Eg1, electrons 81 can be generated in the first semiconductor layer 10.

The peak wavelength of light L1 may be, for example, not less than 230 nm and not more than 700 nm. Electrons 81 are efficiently excited.

The light emitting portion 50 is configured to emit light L1 into the first member 10M having the above-mentioned band gap energy relationship and different conductivity types. For example, the first semiconductor layer 10 is located between the light emitting portion 50 and the first region 21. The electron source 110 may include plurality of light emitting portions 50. The plurality of light emitting portions 50 are arranged along the first face 10F. The light L1 emitted from each of the plurality of light emitting portions 50 may be incident on different positions on the first member 10M. Electrons 81 are emitted from different positions on the first member 10M.

In the first member 10M having the above-mentioned band gap energy relationship and different conductivity types, the first semiconductor layer 10 may include InₓAl_{y}Ga_{1-x-y}N (0≤x≤1, 0≤y≤1, x+y≤1). The first region 21 may include diamond.

The n-type impurity concentration in the first region 21 may be, for example, 1×10¹⁸ cm⁻³ or more. The p-type impurity concentration in the first semiconductor layer 10 may be, for example, 1×10¹⁸ cm⁻³ or more. The n-type carrier concentration in the first region 21 may be, for example, 1×10¹⁸ cm⁻³ or more. The p-type carrier concentration in the first semiconductor layer 10 may be, for example, 1×10¹⁸ cm⁻³ or more. The n-type impurity concentration in the first region 21 may be, for example, 1×10²¹ cm⁻³ or less. The p-type impurity concentration in the first semiconductor layer 10 may be, for example, 1×10²⁰ cm⁻³ or less. The n-type carrier concentration in the first region 21 may be, for example, 1×10²¹ cm⁻³ or less. The p-type carrier concentration in the first semiconductor layer 10 may be, for example, 1×10²⁰ cm⁻³ or less.

In the embodiment, the composition ratio x may be not less than 0 and not more than 0.1. In this case, the composition ratio y may be not less than 0.1 and not more than 0.5. Electrons 81 can move efficiently to the first region 21.

In the embodiment, the composition ratio x may be 0. In this case, the composition ratio y may be not less than 0 and not more than 0.5. The first semiconductor layer 10 is, for example, a ternary nitride layer. Good crystals are easily obtained. High efficiency is easily obtained.

The surface of the second semiconductor layer 20 may be terminated with a second element EL2. The electronegativity of the second element EL2 is lower than the electronegativity of the first element EL1 included in the second semiconductor layer 20. The first element EL1 is, for example, the main element included in the second semiconductor layer 20. With this configuration, for example, an electric dipole ED is generated on the surface of the second semiconductor layer 20, and electrons 81 are effectively emitted from the second semiconductor layer 20 to the outside.

In one example, the first element EL1 may be carbon. In this case, the second element EL2 may be at least one selected from the group consisting of hydrogen, cesium, and scandium. A strong electric dipole ED is easily obtained. High efficiency is easily obtained.

For example, the vacuum level VL is lower than the conduction band energy Ec in the first region 21. Electrons 81 are efficiently emitted to the vacuum (outside).

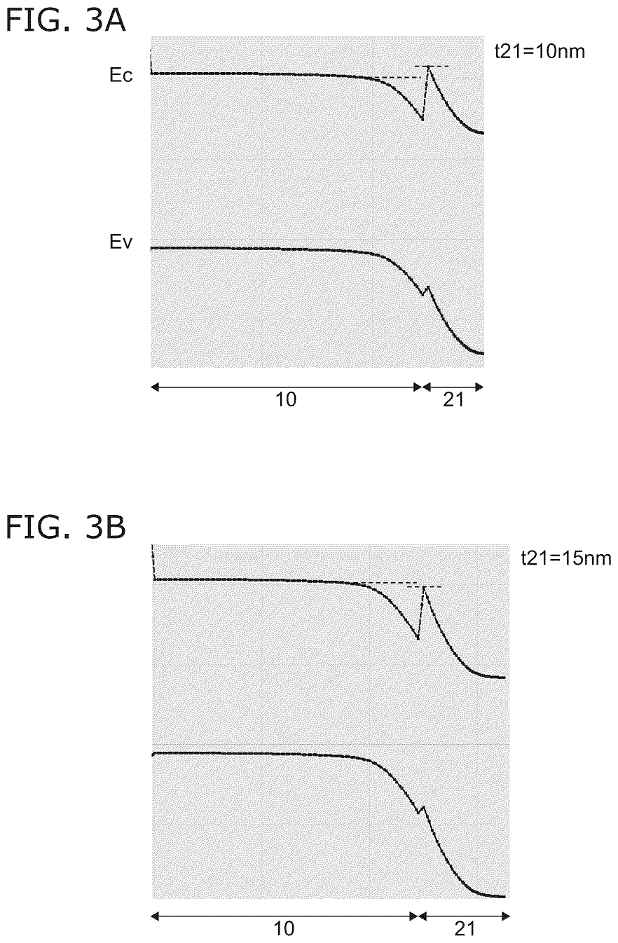

FIGS. 3A and 3B are schematic diagrams illustrating the electron sources according to the first embodiment.

These figures illustrate band profile simulation results. In FIG. 3A, the first region thickness t21 is 10 nm. In FIG. 3B, the first region thickness t21 is 15 nm. In this example, the first semiconductor layer 10 includes InₓAl_{y}Ga_{1-x-y}N (0≤x≤1, 0≤y≤1, x+y≤1). In the examples of FIG. 3A and FIG. 3B, the composition ratio x is 0. The composition ratio y is 0.4. The n-type impurity concentration in the first region 21 is 1×10¹⁹ cm⁻³ or more. The p-type impurity concentration in the first semiconductor layer 10 is 1×10¹⁹ cm⁻³ or more.

As shown in FIG. 3A, when the first region thickness t21 is 10 nm, at the boundary where the first region 21 and the first semiconductor layer 10 contact each other, the conduction band energy Ec in the first region 21 is higher than the conduction band energy Ec in the first semiconductor layer 10.

As shown in FIG. 3B, when the first region thickness t21 is 15 nm, at the boundary where the first region 21 and the first semiconductor layer 10 contact each other, the conduction band energy Ec in the first region 21 is lower than the conduction band energy Ec in the first semiconductor layer 10.

For example, when the first region thickness t21 is 12 nm or more, highly efficient electron emission is easily obtained. The first region thickness t21 may be 15 nm or more.

### Second Embodiment

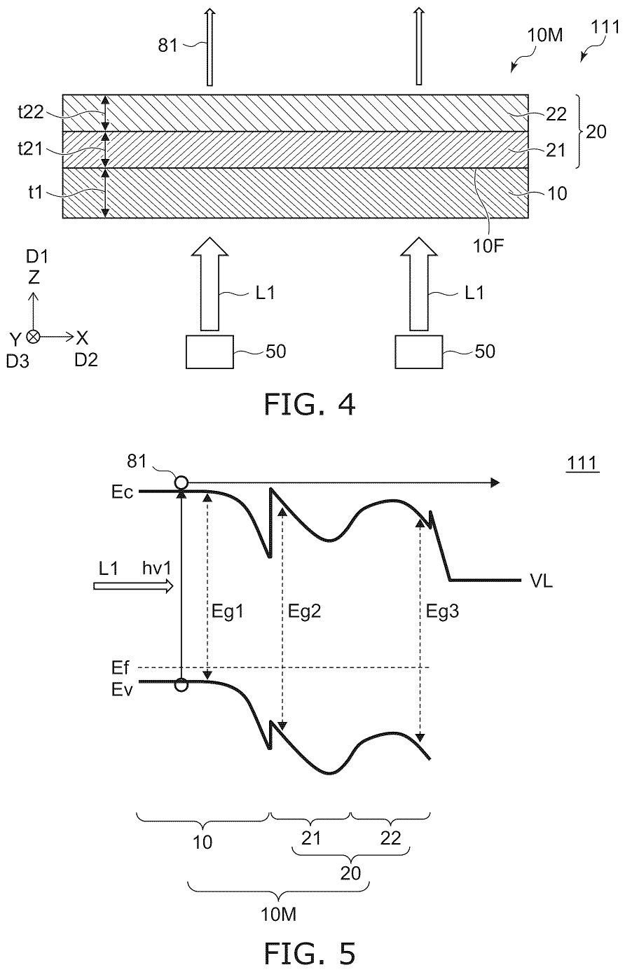

FIG. 4 is a schematic cross-sectional view illustrating an electron source according to a second embodiment.

As shown in FIG. 4, an electron source 111 according to the embodiment includes the first member 10M. In the electron source 111, the second semiconductor layer 20 includes a second region 22 in addition to the first region 21. The configuration of the electron source 111 except for this may be the same as the configuration of the electron source 110.

In the electron source 111, the first region 21 is between the first semiconductor layer 10 and the second region 22. The second region 22 has a third band gap energy Eg3 that is greater than the first band gap energy Eg1, and is p-type. For example, the second region 22 includes diamond and boron.

In such an electron source 111, when the first member 10M is irradiated with light L1, mobile electrons 81 are generated in the first semiconductor layer 10. The generated electrons 81 move efficiently to the first region 21 and further to the second region 22. The electrons 81 are efficiently emitted from the second region 22 to the outside. High electron emission efficiency is obtained. According to the embodiment, an electron source capable of improving characteristics is provided.

As shown in FIG. 4, a thickness of the second region 22 in the first direction D1 from the first semiconductor layer 10 to the first region 21 is defined as a second region thickness t22. The second region thickness t22 may be, for example, not less than 3 nm and not more than 100 nm. By the second region thickness t22 being 3 nm or more, for example, the conductivity of holes increases. For example, positive charging due to electron emission can be suppressed. By the second region thickness t22 being 100 nm or less, for example, the conduction band energy Ec in the second region decreases. For example, it becomes easier to obtain electron emission with high efficiency. FIG. 5 is a schematic diagram illustrating an electron source according to the second embodiment.

FIG. 5 illustrates a band profile in the electron source 111. The third band gap energy Eg3 of the second region 22 is, for example, larger than the first band gap energy Eg1. When light L1 is incident on the first semiconductor layer 10, the electron 81 is excited to the conduction band energy Ec by the energy hv1 of the light L1. The electron 81 moves from the first semiconductor layer 10 to the first region 21, over the barrier between the conduction band energy Ec in the first semiconductor layer 10 and the conduction band energy Ec in the first region 21, and further moves to the second region 22. The electron 81 that has moved to the second region 22 is efficiently emitted from the second region 22 to the outside.

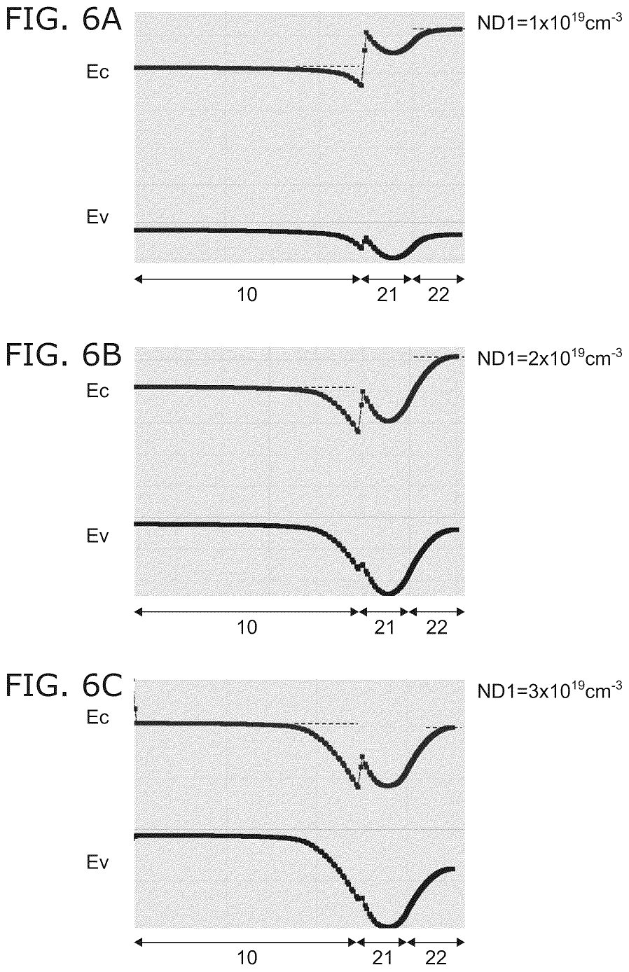

FIGS. 6A to 6C are schematic diagrams illustrating electron sources according to the second embodiment.

These figures illustrate the results of band profile simulations. In FIG. 6A, the impurity concentration ND1 of n-type in the first region 21 is 1×10¹⁹ cm⁻³. In FIG. 6B, the impurity concentration ND1 n-type in the first region 21 is 2×10¹⁹ cm⁻³. In FIG. 6C, the impurity concentration ND1 of n-type in the first region 21 is 3×10¹⁹ cm⁻³. In these examples, the p-type impurity concentration in the second region 22 is 1×10¹⁹ cm⁻³. In these examples, the first region 21 and the second region 22 are diamond. The first semiconductor layer 10 includes InₓAl_{y}Ga_{1-x-y}N (0<x<1, 0<y<1, x+y<1). The composition ratio x is 0. The composition ratio y is 0.4. In these examples, each of the first region thickness t21 and the second region thickness t22 is 10 nm.

As shown in FIG. 6A, in this example, when the impurity concentration ND1 is 1×10¹⁹ cm⁻³, the conduction band energy Ec in the second region 22 is higher than the conduction band energy Ec in the first semiconductor layer 10.

As shown in FIG. 6B, in this example, when the impurity concentration ND1 is 2×10¹⁹ cm⁻³, the conduction band energy Ec in the second region 22 is lower than the conduction band energy Ec in the first semiconductor layer 10. Highly efficient electron emission is obtained.

As shown in FIG. 6C, in this example, when the impurity concentration ND1 is 3×10¹⁹ cm⁻³, the conduction band energy Ec in the second region 22 is significantly lower than the conduction band energy Ec in the first semiconductor layer 10. Highly efficient electron emission is obtained.

In the embodiment, for example, the potential of the diamond layer is lowered due to the diffusion potential of the junction between the p-type electron supply layer and the n-type diamond layer. This reduces the energy barrier between the electron supply layer and the diamond. Highly efficient electron emission is obtained.

### Third Embodiment

The third embodiment relates to an electronic device. The electronic device includes the electron source (e.g., electron source 110 or electron source 111) according to the first or second embodiment. The electronic device may include, for example, at least one selected from the group consisting of an electron beam drawing device, a processing device, and an analysis device. An electronic device capable of improving characteristics is provided.

Information about length and thickness can be obtained by observation using an electron microscope, etc. Information about the composition of the material can be obtained by SIMS (Secondary Ion Mass Spectrometry) or EDX (Energy dispersive X-ray spectroscopy), etc. Information about the energy of the material can be obtained based on information about the composition of the material.

The embodiments may include the following Technical proposals:

### Technical Proposal 1

An electron source, comprising:
a first member including:
   a first semiconductor layer of p-type, the first semiconductor layer having a first bandgap energy;
   a second semiconductor layer including a first region, the first region having a second bandgap energy larger than the first bandgap energy, the first region being of n-type.

### Technical Proposal 2

The electron source according to Technical proposal 1, wherein
the first semiconductor layer includes InₓAl_{y}Ga_{1-x-y}N (0≤x≤1, 0≤y≤1, x+y≤1).

### Technical Proposal 3

The electron source according to Technical proposal 2, wherein

the first region includes diamond.

### Technical Proposal 4

An electron source comprising:
a first member including:
   a first semiconductor layer including InₓAl_{y}Ga_{1-x-y}N (0≤x≤1, 0≤y≤1, x+y≤1) and including magnesium;
   a second semiconductor layer including a first region, the first region including diamond and including a first element including at least one selected from the group consisting of phosphorus and nitrogen.

### Technical Proposal 5

The electron source according to Technical proposal 4, wherein
the second semiconductor layer is configured to emit electrons in response to light incident on the first member.

### Technical Proposal 6

The electron source according to any one of Technical proposals 1-3, wherein
the second semiconductor layer is configured to emit electrons in response to light incident on the first member.

### Technical Proposal 7

The electron source according to Technical proposal 6, wherein
energy of the light is greater than the first band gap energy.

### Technical Proposal 8

The electron source according to Technical proposal 7 further including:
a light-emitting portion,
the light-emitting portion being configured to cause the light to be incident on the first member.

### Technical Proposal 9

The electron source according to Technical proposal 8, wherein
a plurality of the light emitting portions are provided,
the first semiconductor layer includes a first face facing the first region, and
the plurality of the light emitting portions are arranged along the first face.

### Technical Proposal 10

The electron source according to Technical proposal 8 or 9, wherein
the first semiconductor layer is located between the light emitting portion and the first region.

### Technical Proposal 11

The electron source according to Technical proposal 8 or 9, wherein
peak wavelength of the light is not less than 230 nm and not more than 700 nm.

### Technical Proposal 12

The electron source according to any one of technical proposals 1-3, wherein
the second semiconductor layer further includes a second region,
the first region is located between the first semiconductor layer and the second region, and
the second region has a third band gap energy larger than the first band gap energy, and is p-type.

### Technical Proposal 13

The electron source according to Technical proposal 4 or 5, wherein
the second semiconductor layer further includes a second region,
the first region is located between the first semiconductor layer and the second region, and
the second region includes diamond and includes boron.

### Technical Proposal 14

The electron source according to Technical proposal 13, wherein
a second region thickness of the second region in the first direction from the first semiconductor layer to the first region is not less than 3 nm and not more than 100 nm.

### Technical Proposal 15

The electron source according to any one of Technical proposals 1-13, wherein
a first region thickness of the first region in the first direction from the first semiconductor layer to the first region is 12 nm or more.

### Technical Proposal 16

The electron source according to any one of Technical proposals 1-3, in which the n-type impurity concentration in the first region is 1×10¹⁸ cm⁻³ or more.

### Technical Proposal 17

The electron source according to any one of technical proposals 1-3, wherein
a p-type impurity concentration in the first semiconductor layer is 1×10¹⁸ cm⁻³ or more.

### Technical Proposal 18

The electron source according to Technical proposal 4 or 5, wherein
a concentration of the first element in the first region is 1×10¹⁸ cm⁻³ or more, and
a concentration of magnesium in the first semiconductor layer is 1×10¹⁸ cm⁻³ or more.

### Technical Proposal 19

The electron source according to Technical proposal 4 or 5, wherein
x is not less than 0 and not more than 0.5, and
y is not less than 0 and not more than 0.1.

### Technical Proposal 20

The electron source according to Technical proposal 4 or 5, wherein
x is not less than 0 and not more than 0.1, and
y is not less than 0.1 and not more than 0.5.

According to the embodiment, an electron source and an electronic device are provided that can improve the characteristics.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the electron sources such as members, semiconductor layers, light emitting portions, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all electron sources practicable by an appropriate design modification by one skilled in the art based on the electron sources described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An electron source, comprising:
a first member including:
a first semiconductor layer of p-type, the first semiconductor layer having a first bandgap energy;
a second semiconductor layer including a first region, the first region having a second bandgap energy larger than the first bandgap energy, the first region being of n-type.

2. The electron source according to claim 1, wherein
the first semiconductor layer includes InₓAl_{y}Ga_{1-x-y}N (0≤x≤1, 0≤y≤1, x+y≤1).

3. The electron source according to claim 2, wherein
the first region includes diamond.

4. An electron source comprising:
a first member including:
a first semiconductor layer including InₓAl_{y}Ga_{1-x-y}N (0≤x≤1, 0≤y≤1, x+y≤1) and including magnesium;
a second semiconductor layer including a first region, the first region including diamond and including a first element including at least one selected from the group consisting of phosphorus and nitrogen.

5. The electron source according to claim 4, wherein
the second semiconductor layer is configured to emit electrons in response to light incident on the first member.

6. The electron source according to claim 1, wherein
the second semiconductor layer is configured to emit electrons in response to light incident on the first member.

7. The electron source according to claim 6, wherein
energy of the light is greater than the first band gap energy.

8. The electron source according to claim 7 further including:
a light-emitting portion,
the light-emitting portion being configured to cause the light to be incident on the first member.

9. The electron source according to claim 8, wherein
a plurality of the light emitting portions are provided,
the first semiconductor layer includes a first face facing the first region, and
the plurality of the light emitting portions are arranged along the first face.

10. The electron source according to claim 8, wherein
the first semiconductor layer is located between the light emitting portion and the first region.

11. The electron source according to claim 8, wherein
peak wavelength of the light is not less than 230 nm and not more than 700 nm.

12. The electron source according to claim 1, wherein
the second semiconductor layer further includes a second region,
the first region is located between the first semiconductor layer and the second region, and
the second region has a third band gap energy larger than the first band gap energy, and is p-type.

13. The electron source according to claim 4, wherein
the second semiconductor layer further includes a second region,
the first region is located between the first semiconductor layer and the second region, and
the second region includes diamond and includes boron.

14. The electron source according to claim 13, wherein
a second region thickness of the second region in the first direction from the first semiconductor layer to the first region is not less than 3 nm and not more than 100 nm.

15. The electron source according to claim 1, wherein
a first region thickness of the first region in the first direction from the first semiconductor layer to the first region is 12 nm or more.

16. The electron source according to claim 1, wherein the n-type impurity concentration in the first region is 1×10¹⁸ cm⁻³ or more.

17. The electron source according to claim 1, wherein
a p-type impurity concentration in the first semiconductor layer is 1×10¹⁸ cm⁻³ or more.

18. The electron source according to claim 4, wherein
a concentration of the first element in the first region is 1×10¹⁸ cm⁻³ or more, and
a concentration of magnesium in the first semiconductor layer is 1×10¹⁸ cm⁻³ or more.

19. The electron source according to claim 4, wherein
x is not less than 0 and not more than 0.5, and
y is not less than 0 and not more than 0.1.

20. The electron source according to claim 4, wherein
x is not less than 0 and not more than 0.1, and
y is not less than 0.1 and not more than 0.5.
